(19) United States
(12) Patent Application Publication
(10) Pub. No.: US 2024/0364088 A1
(43) Pub. Date: Oct. 31, 2024

(54) ELECTRIC BOX FACEPLATE AND MOUNTING MEMBER FOR SUPPORTING OBJECTS ON A WALL AND METHOD OF USE

(71) Applicants: Stephen Manno, Sayville, NY (US); Herbert Frederick Ruschmann, East Norwich, NY (US)

(72) Inventors: Stephen Manno, Sayville, NY (US); Herbert Frederick Ruschmann, East Norwich, NY (US)

(21) Appl. No.: 18/139,084

(22) Filed: Apr. 25, 2023

(51) Int. Cl. H02G 3/14

(52) U.S. Cl. CPC H02G 3/14

(57) ABSTRACT

A faceplate is configured to mount to at least one of an electrical box or an electrical receptacle or switch. The faceplate has one or more notches or grooves configured to accept a mounting member for supporting objects on a wall via the mounting member engagement with the faceplate. An object to be supported is optionally configured to engage the faceplate obviating a need for a mounting member. In an embodiment the faceplate has one or more notches or grooves in a top side. In another embodiment the faceplate has one or more notches or grooves in vertical sides. In a further embodiment the faceplate has one or more notches or grooves in both the top side and the vertical sides.

### BACKGROUND

The present invention relates to an electrical box faceplate, an optional engageable mounting member, and a shelf unit which can mount to an electrical box faceplate.

Conventional electrical box faceplates provide an aesthetic covering of switches and receptacles and prevent access to electrical component connections within the electrical box housing of either electrical receptacles or switches. Numerous electronic devices are employed daily and require charging via electrical receptacles. Often there is not a convenient surface near the receptacle to rest such devices on while charging, or one does not wish to take up space on a nearby surface with charging devices. Electric light switches are located in places normally adjacent an entrance to a room whereat a person entering may wish to set down carried items. Also, since such a location is readily accessible it is often desirable to have a shelf, or hooks for keys, or other articles at that location so items may be readily disposed or retrieved when entering or leaving a room. In order to install a shelf or other object, such as a key rack, clothing rack, or the like it is necessary to put holes in wallboard at the location which requires use of drills and also mars the wallboard. Such marring is unsightly if the shelf or object is later removed and wall repair and painting is required to restore an acceptable appearance.

The are also attachment devices which use adhesive to secure items to a wall. While these devices avoid putting holes in wallboard, the devices are often only suited for light duty applications and are prone to detachment if overloaded. Additionally, later removal of such devices will often leave visible scarring on painted wallboard thus requiring cleaning and painting to restore an acceptable appearance.

### SUMMARY

Accordingly, it is an object of the invention to provide a device for supporting objects on a wall which overcomes the drawbacks of the prior art.

It is a further object of the invention to provide a device which allows attachment of objects to a wall without marring or putting holes in a wall.

It is a still further object of the invention to provide a device which allows attachment of objects to a wall which is not dependent on adhesion of paint to a wall surface for support.

It is a yet a further object of the invention to provide a device which allows attachment of objects to a wall and later removal without leaving unsightly damage to the wall.

It is a yet a further object of the invention to provide a device which allows attachment of a shelf unit to a wall and later removal without leaving unsightly damage to the wall.

Briefly stated, the present invention provides a faceplate is configured to mount to at least one of an electrical box or an electrical receptacle or switch. The faceplate has one or more notches or grooves configured to accept a mounting member for supporting objects on a wall via the mounting member engagement with the faceplate. An object to be supported is optionally configured to engage the faceplate obviating a need for a mounting member. In an embodiment the faceplate has one or more notches or grooves in a top side. In another embodiment the faceplate has one or more notches or grooves in vertical sides. In a further embodiment the faceplate has one or more notches or grooves in both the top side and the vertical sides.

In accordance with these and other objects of the invention, there is provided an embodiment of a faceplate for attaching to at least one of an electrical box and an electrical device in the electrical box and covering a wallboard opening in a wall in which the electrical box is mounted, wherein the electrical device has protruding surface. The faceplate comprises a plate having a front side, a top side, right and left sides, a bottom side, and back side. The plate defines an electrical device protrusion aperture in the front side extending through the plate and configured to receive the protruding surface of the electrical device. The plate defines at least one fastener receiving aperture positioned to receive a screw for fastening the plate to one of the electric device or the electric box. The plate includes a notch in at least one of the top side, the left side, or the right side.

The present invention also provides the above embodiment wherein the notch is formed in the top side, and the notch forms a flange and a notch bottom surface, the flange having a top edge and a flange back surface extending from the top edge to the notch bottom. A still further embodiment is provided wherein the plate includes a rib extending along at least a portion of a perimeter of the back side, and the rib having a top edge forming the notch bottom surface. In an embodiment the rib defines a concavity configured to receive a portion of the electrical device.

According to a feature of the invention there is provided a kit for mounting a structure to a wall comprising the above faceplate and a mounting member configured to fit in the notch. The mounting member optionally includes at least one aperture configured to receive a screw for attaching the mounting member to the structure.

The present invention further provides a method for mounting a structure to a wall including an electrical box and an electrical device situated in the electrical box comprising steps of providing the above kit, attaching the mounting member to the structure, and fastening the faceplate to one of an electrical box or an electrical device in the electrical box with the mounting member disposed between the flange and the wall. The method optionally includes clamping the mounting member to the wall.

According to another feature of the invention, there is further provided an embodiment of the faceplate wherein the rib has outer right and left edges respectively recessed from the right side and the left side of the plate to define right and left side notches with side walls forming right and left side flanges. The aforesaid embodiments include the notch and the flange back surface extending from the right side to the left side. Alternatively, the aforesaid embodiments include the notch and the flange back surface not extending to the right side and the left side. The present invention further includes a kit for mounting a structure to a wall comprising the aforesaid embodiment of the faceplate and a mounting member having an edge configured to fit in the top notch and having right and left arms respectively configured to fit the right and left side notches. The mounting member is optionally provided with at least one aperture configured to receive a screw for attaching the mounting member to the structure.

According to a still further feature of the invention, there is further provided a method for mounting a structure to a wall including an electrical box and an electrical device situated in the electrical box comprising steps of providing the above kit, attaching the mounting member to the structure, fastening the faceplate to one of an electrical box or an electrical device in the electrical box, and disposing the mounting member with the edge in the top notch and the right and left arms respectively in the right and left side notches. In a further method embodiment the fastening includes clamping the mounting member to the wall.

A still further embodiment of the present invention provides the faceplate wherein the notch includes right and left notches respectively formed in the right and left sides of the plate, the right and left notches respectively forming right and left flanges and right and left notch bottom surfaces, and the right and left notches extending from the top side of the plate to form notch openings in the top side. Optionally the plate includes a rib extending along at least a portion of a perimeter of the back side, and the rib forming a bottom of the right and left notches and extending along at least a portion of the top side of the plate to form a plate top surface. The rib optionally defines a concavity configured to receive a portion of the electrical device.

Further provided is a kit for mounting a structure to a wall comprising the above faceplate and a mounting member having right and left arms configured to respectively fit in the right and left notches and an edge disposed to engage the top surface when the right and left arms are fit in the right and left notches. The mounting member optionally includes at least one aperture configured to receive a screw for attaching the mounting member to the structure.

Further provided is a method for mounting a structure to a wall including an electrical box and an electrical device situated in the electrical box comprising steps of providing the above kit, attaching the mounting member to the structure, and fastening the faceplate to one of an electrical box or an electrical device in the electrical box with the mounting member disposed to have the right and left arms respectively in the right and left notches and the edge contacting the top surface. The fastening optionally includes clamping the right and left arms respectively between the right and left flanges and the wall.

A further embodiment of the present invention includes the faceplate of an above embodiment wherein the notch is formed in the top side, and the notch forms a front flange, a back flange, and a notch bottom surface defining a top side groove. The embodiment optionally includes a rib extending along at least a portion of a perimeter of the back side, and the rib forming the top side and including the top side groove. In an embodiment the rib optionally defines a concavity configured to receive a portion of the electrical device.

The present invention further provides a kit for mounting a structure to a wall comprising the above faceplate and a mounting member configured to fit in the top side groove. In an embodiment the mounting member includes at least one aperture configured to receive a screw for attaching the mounting member to the structure.

Further provided is a method for mounting a structure to a wall including an electrical box and an electrical device situated in the electrical box comprising steps of providing the above kit, attaching the mounting member to the structure, fastening the faceplate to one of an electrical box or an electrical device in the electrical box, and disposing the mounting member in the top side groove.

In a further embodiment of the faceplate, the rib has a rib right edge and a rib left edge respectively comprising portions of the right and left sides of the plate, the rib right and left edges respectively including right and left side notches defining right and left side grooves extending from the top side and along at least portions of the right and left sides of the plate, the right and left side grooves being aligned with the top side groove. The top side groove optionally extends from the right side to the left side and coincides with the right and left side grooves respectively at the right side and the left side.

The invention further provides a kit for mounting a structure to a wall comprising the above faceplate and a mounting member configured to fit in the top side groove and having arms configured to fit the right and left side grooves. The mounting member optionally includes at least one aperture configured to receive a screw for attaching the mounting member to the structure.

Still further provided is a method for mounting a structure to a wall including an electrical box and an electrical device situated in the electrical box comprising steps of providing the above kit, attaching the mounting member to the structure, fastening the faceplate to one of an electrical box or an electrical device in the electrical box, and disposing the mounting member in the top side groove and the right and left side grooves.

Yet another embodiment of the faceplate is provided wherein the plate includes a rib extending along at least a portion of a perimeter of the back side, and the rib forming a plate top surface at the top side of the plate. The rib has a rib right edge and a rib left edge respectively comprising portions of the right and left sides of the plate. The notch includes right and left side notches formed in the rib right and left edges respectively and defining right and left side grooves extending from the top side and along at least portions of the right and left sides of the plate.

The invention further provides a kit for mounting a structure to a wall comprising the above faceplate and a mounting member having right and left arms configured to respectively fit in the right and left side grooves and an edge disposed to engage the plate top surface when the right and left arms are fit in the right and left notches. Optionally the mounting member includes at least one aperture configured to receive a screw for attaching the mounting member to the structure.

Further provided is a method for mounting a structure to a wall including an electrical box and an electrical device situated in the electrical box comprising steps of providing the above kit, attaching the mounting member to the structure, fastening the faceplate to one of an electrical box or an electrical device in the electrical box, and disposing the mounting member with the right and left arms respectively in the right and left side grooves and the edge contacting the plate top surface.

In a further embodiment of the present invention there is provided a kit including any of the aforesaid kits and further comprising the fastener receiving aperture being disposed to align with a threaded screw hole in the electrical box. The plate having a second fastener receiving aperture disposed to align with a threaded screw hole in the electrical device. Also provided is an electrical device fastening screw configured to secured the plate to the electrical device when passed through the second receiving aperture and threaded into the threaded screw hole of the electrical device. Additionally provided is an electrical box fastening screw having a head, a shank, and a threaded portion configured to screw into the threaded screw hole in the electrical box. The fastener receiving aperture is configured to accept the head and the shank and has an aperture depth. The shank has a length exceeding an aperture depth such that the shank engages the electrical device when the electrical device is secured to the plate and the plate is secured to the electrical box by the electrical box fastening screw thereby ensuring grounding of the electrical device to the electrical box.

The above, and other objects, features and advantages of the present disclosure will become apparent from the following description read in conjunction with the accompanying drawings, in which like reference numerals designate the same elements. The present disclosure is considered to include all functional combinations of the above described features and corresponding descriptions contained herein, and all combinations of further features described herein, and is not limited to the particular structural embodiments shown in the figures as examples. The scope and spirit of the present disclosure is considered to include modifications as may be made by those skilled in the art having the benefit of the present disclosure which substitute, for elements presented in the claims, devices or structures upon which the claim language reads or which are equivalent thereto, and which produce substantially the same results associated with those corresponding examples identified in this disclosure for purposes of the operation of this disclosure. Additionally, the scope and spirit of the present disclosure is intended to be defined by the scope of the claim language itself and equivalents thereto without incorporation of structural or functional limitations discussed in the specification which are not referred to in the claim language itself.

The foregoing is a summary and thus contains, by necessity, simplifications, generalizations, and omissions of detail; consequently, those skilled in the art will appreciate that the summary is illustrative only and is not intended to be in any way limiting. Additional features and advantages of various embodiments of the present disclosure will be set forth in part in the non-limiting description that follows, and in part, will be apparent from the non-limiting drawings, or may be learned by practice of various embodiments. The objectives and other advantages of various embodiments will be realized and attained by means of the elements and combinations particularly pointed out in the description and appended claims.

### BRIEF DESCRIPTION OF THE DRAWINGS

In part, other aspects, features, benefits and advantages of the embodiments will be apparent with regard to the following description, appended claims and accompanying drawings wherein:

FIG. 1A is a rear view of an embodiment of shelf unit including an embodiment of a mounting member, each of the present invention;

FIG. 1B is a left side elevation view of the shelf unit and mounting member of FIG. 1A;

FIG. 1C is a front side elevation view of the shelf unit and mounting member of FIGS. 1A and 1B shown, via a cut away view, mounted using an embodiment of a faceplate of the present invention;

FIG. 1D is a rear view of another embodiment of shelf unit including an embodiment of a mounting member incorporated into the shelf unit, each of the present invention;

FIG. 1E is a left side elevation view of the shelf unit and mounting member of FIG. 1D;

FIG. 1F is a front side elevation view of the shelf unit and mounting member of FIGS. 1D and 1E shown, via a cut away view, mounted using the embodiment of a faceplate of FIG. 1C;

FIG. 2 is a front side elevation view of the faceplate of FIG. 1F showing dimension variables, and the faceplate having receptacle fastening holes, oblong clearance holes, and a receptacle aperture;

FIG. 2A is a right side elevation view of the faceplate of FIG. 2 showing dimension variables and a profile of a top notch;

FIG. 2B is a top plan view of the faceplate of FIG. 2 showing a top plan view of the top notch;

FIG. 3 is a rear side elevation view of the faceplate of FIG. 2 showing dimension variables, a rib, a recessed area, a notch along a top side, and the faceplate having the receptacle fastening holes, oblong clearance holes, and the receptacle aperture;

FIG. 3A is a left side cross-sectional view of the faceplate of FIG. 2 taken along line III-A-III-A showing dimension variables;

FIG. 3B is a top plan cross-sectional view of the faceplate of FIG. 2 taken along line III-B-III-B;

FIG. 3C is a rear side elevation view of an alternative embodiment the faceplate of FIG. 2 showing dimension variables, a rib modified to extend across the faceplate, a recessed area, a notch along a top side, and the faceplate having the receptacle fastening holes, oblong clearance holes, and the receptacle aperture;

FIG. 4A is an exploded right side assembly view of the faceplate of FIG. 2, an embodiment of a mounting member of the present invention, an electrical receptacle, an electrical box, screws, and a wallboard;

FIG. 4B is a front elevation view of a conventional electrical receptacle;

FIG. 4C is a front elevation view of the mounting member of FIG. 4A;

FIG. 4D is a right side elevation partial cross-sectional assembled view of components of FIG. 4A showing the faceplate of FIG. 2 mounted to a receptacle bracket, the receptacle bracket mounted to ears of the electrical box, and the faceplate clamping the mounting member to the wallboard;

FIG. 4E is a right side elevation view of an embodiment of mounting member of the present invention showing an optional countersunk hole and an optional elastic member;

FIG. 5 is a rear side elevation view of another embodiment the faceplate of FIG. 2 showing dimension variables, a rib, a recessed area, a top notch along a top side, and right and left side notches extending along right and left sides of the faceplate, and the faceplate having the receptacle fastening holes, oblong clearance holes, and the receptacle aperture;

FIG. 5A is a left side elevation view of the faceplate of FIG. 5 showing the right side notch and the top notch;

FIG. 5B is a top plan view of the faceplate of FIG. 5 showing the top notch, right and left side notches, and a view over the recessed area;

FIG. 5C is a left side cross-sectional elevation view of the faceplate of FIG. 5 taken along line V-C-V-C showing a profile of the rib, the top notch, and a view over the recessed area;

FIG. 5D is a plan cross-sectional elevation view of the faceplate of FIG. 5 taken along line V-D-VD showing a profile of the rib, the right and left side notches, and a view over the recessed area;

FIG. 5E is an front elevation exploded assembly view of an embodiment of the faceplate of FIG. 5 having oblong clearance holes replaced by box fastening holes and showing the rib by see-through dashed line, another embodiment of a mounting member having a forked configuration, and a wallboard;

FIG. 5F is an front elevation assembled view of the components of FIG. 5E further showing screws which mount the receptacle bracket to the faceplate, and screws that mount the faceplate to an electrical box;

FIG. 5G is a front side elevation view of another embodiment of a forked mounting member of the present invention have a top right angle extension including mounting screw holes;

FIG. 5H is a left side elevation view of the forked mounting member of FIG. 5G;

FIG. 6 is a front side elevation view of another embodiment the faceplate of FIG. 2 showing a rib, a top groove bottom, and a recessed area in see-through dashed lines, and the faceplate having the receptacle fastening holes, oblong clearance holes, and the receptacle aperture;

FIG. 6A is a right side elevation view of the faceplate of FIG. 6 showing a profile of the top groove;

FIG. 6B is a top plan view of the faceplate of FIG. 6 showing the top groove;

FIG. 6C is a right side cross-sectional elevation view of the faceplate of FIG. 6 taken along line VI-C-VI-C showing a profile of the top groove, an interior side view of the rib, and a view over the recessed area;

FIG. 6D is a top plan cross-sectional elevation view of the faceplate of FIG. 6 taken along line VI-D-VI-D showing a plan profile of the rib, and a view over the recessed area;

FIG. 7 is a rear side elevation view of another embodiment the faceplate of FIG. 2 showing a rib, a right and left side notches, a recessed area, and the faceplate having the receptacle fastening holes, oblong clearance holes, and the receptacle aperture;

FIG. 7A is a right side elevation view of the faceplate of FIG. 7 showing the right side notch;

FIG. 7B is a top plan view of the faceplate of FIG. 7 showing profiles of the right and left side notches

FIG. 7C is a right side cross-sectional elevation view of the faceplate of FIG. 7 taken along line VII-C-VII-C showing a profile and an interior side view of the rib, and a view over the recessed area;

FIG. 7D is a top plan cross-sectional elevation view of the faceplate of FIG. 7 taken along line VII-D-VII-D showing a plan profile and an interior top plan side view of the rib, and profiles of the right and left side notches;

FIG. 8 is a rear side elevation view of another embodiment the faceplate of FIG. 2 showing a rib, a right, left and top side grooves defined by groove bottoms shown in dashed line see-through views, a recessed area, and the faceplate having the receptacle fastening holes, oblong clearance holes, and the receptacle aperture;

FIG. 8A is a right side elevation view of the faceplate of FIG. 8 showing the right side groove and top side grooves in profile;

FIG. 8B is a top plan view of the faceplate of FIG. 8 showing profiles of the right and left side grooves and a top plan view of the top side grooves

FIG. 8C is a right side cross-sectional elevation view of the faceplate of FIG. 8 taken along line VIII-C-VIII-C showing a profile and an interior side view of the rib and top side groove, and a view over the recessed area showing an interior side of the rib;

FIG. 8D is a top plan cross-sectional elevation view of the faceplate of FIG. 8 taken along line VIII-D-VIII-D showing a plan profile of the right and left sides of the rib and grooves, and an interior top plan interior side view of the rib;

FIG. 9A is a front side elevation view of an embodiment of any of the aforesaid embodiments of the faceplate of FIG. 2 having the receptacle fastening holes, and oblong box fastening holes in place of oblong clearance holes;

FIG. 9B is a front side elevation view of an embodiment of any of the aforesaid embodiments of the faceplate of FIG. 2 having the receptacle fastening holes, and the oblong clearance holes replaced by box fastening holes;

FIG. 9C is a front side elevation view of an embodiment of any of the aforesaid embodiments of the faceplate of FIG. 2 having the receptacle fastening holes and the oblong clearance holes omitted;

FIG. 9D is a front side elevation view of an embodiment of any of the aforesaid embodiments of the faceplate of FIG. 2 having the oblong clearance holes, the receptacle aperture replaced by two older format receptacle apertures, and the receptacle fastening holes replaced by a single receptacle fastening hole;

FIG. 9E is a front side elevation view of an embodiment of any of the aforesaid embodiments of the faceplate of FIG. 2 having the receptacle aperture replaced by two older format receptacle apertures, the oblong clearance holes replaced by the oblong box fastening holes, and the receptacle fastening holes replaced by a single receptacle fastening hole;

FIG. 9F is a front side elevation view of an embodiment of any of the aforesaid embodiments of the faceplate of FIG. 2 having the receptacle aperture replaced by two older format receptacle apertures, the oblong clearance holes replaced by the box fastening holes, and the receptacle fastening holes replaced by a single receptacle fastening hole;

FIG. 9G is a front side elevation view of an embodiment of any of the aforesaid embodiments of the faceplate of FIG. 2 having the receptacle aperture replaced by two older format receptacle apertures, the oblong clearance holes omitted, and the receptacle fastening holes replaced by a single receptacle fastening hole;

FIG. 10A is a right side elevation partial cross-sectional assembled view of an embodiment of a faceplate 10-1a, which is the same as the faceplate 10-1 modified to have the screw hole configuration of FIG. 9B, an electrical receptacle, and an electrical box secured together with receptacle fastening screws and electrical box screws 64;

FIG. 10B is a side elevation view of a modified electrical box screw having a shank portion configured to engage a front of an electric receptacle bracket;

FIG. 10C is a right side elevation partial cross-sectional assembled view of an embodiment of a faceplate 10-1a, which is the same as the faceplate 10-1 modified to have oblong clearance holes replaced by countersunk holes configured for receiving the modified electrical box screw of FIG. 10B for effecting secure electrical contact between an electric receptacle bracket and the electrical box;

FIG. 11A a front elevation exploded assembly diagram a partial view of an embodiment of a faceplate of FIG. 3 or FIG. 6 modified to have a top surface indentation not extending to the sides of the faceplate and a mounting member having a tab adapted to fit the modified faceplate;

FIG. 11B is a top plan view of the faceplate of FIG. 3 modified to have a top surface notch not extending to the sides of the faceplate;

FIG. 11C is a top plan view of the faceplate of FIG. 6 modified to have a top surface groove not extending to the sides of the faceplate;

FIG. 12A a front elevation exploded assembly diagram a partial view of an embodiment of a faceplate of FIG. 3 or FIG. 6 modified to have a top surface indentations at side and not in a central portion and a mounting member having tabs adapted to fit the modified faceplate;

FIG. 12B is a top plan view of the faceplate of FIG. 3 modified to have a top surface notches at sides thereof and not in a central portion of the faceplate;

FIG. 12C is a top plan view of the faceplate of FIG. 6 modified to have a top surface grooves at sides thereof not in a central portion of the faceplate;

FIG. 13A shows a profile of a modified notch optionally used in the faceplate of FIG. 3 or any modification thereof;

FIG. 13B shows a profile of a modified notch optionally used in the faceplate of FIG. 3 or any modification thereof;

FIG. 14A shows a profile of a modified groove optionally used in the faceplate of FIG. 6 or any modification thereof; and

FIG. 14B shows a profile of a modified groove optionally used in the faceplate of FIG. 6 or any modification thereof.

It is to be understood that the figures are not drawn to scale unless so indicated. Further, the relationship between objects in a figure may not be to scale, and may in fact have a reverse relationship as to size unless so indicated. The figures are intended to bring understanding and clarity to the structure of each object shown, and thus, some features may be exaggerated in order to illustrate a specific feature of a structure. Accordingly, the figures are not intended to limit the scope and breadth of the appended claims.

### DETAILED DESCRIPTION OF THE PREFERRED EMBODIMENT

Reference will now be made in detail to various embodiments of the present disclosure, examples of which are illustrated in the accompanying drawings. While the embodiments of the present disclosure will be described in conjunction with the illustrated embodiments, it will be understood that they are not intended to limit the disclosure to those embodiments. On the contrary, the disclosure is intended to cover all alternatives, modifications, and equivalents, which may be included within the disclosure as defined by the appended claims. Furthermore, the following explanations of nomenclature, phrasing, and intended interpretations are to be applied when determining meaning of the description and appended claims.

### Headings

Headings where presented below are not meant to limit the disclosure in any way; embodiments under any one heading may be used in conjunction with embodiments under any other heading.

### Singular Includes Plurality

With regard to the following description it is to be understood by those skilled in the art that unless a specific number of an introduced claim element is recited in the claim, such claim element is not limited to a certain number. For example, introduction of a claim element using the indefinite article “a” or “an” to introduce a first element does not limit the claim to “one” of the first element. Still further, it is to be understood that the appended claims may contain usage of the introductory phrases “at least one” and “one or more” to introduce claim elements and that such phraseology does not alter the foregoing interpretation of the articles “a” or “an.” Such phrases are not considered to imply that the introduction of a claim element by the indefinite articles “a” or “an” limits any particular claim containing such introduced claim element to coverage of devices or processes containing only one such element or containing more than one such element, even when the same claim includes the introductory phrases “one or more” or “at least one.”

### Selection of Elements

It is to be further understood that claim terminology relating to elements A, B, and C recited as “one of A, B, and C” is intended to cover devices or processes having one or more of element A, or one or more of element B, or one or more of element C, and does not require the presence of three of such elements A, B, and C nor exclude coverage of devices or processes including the presence of three of such elements A, B, and C. Likewise, recitation of “at least one of A, B, and C” is to be given the same interpretation. On the other hand, if it is intended to limit coverage of a claim to devices or processes including one of each of a set of elements, the phraseology “one of each of A, B, and C” or “at least one of each of A, B, and C” is used. Still further, use of “or” in place of “and” in the above phrases is not intended to alter the meanings indicated above.

### Quantities and Proportions

For the purposes of this specification and appended claims, unless otherwise indicated, all numbers expressing quantities of ingredients, percentages or proportions of materials, reaction conditions, and other numerical values used in the specification and claims, are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present disclosure. At the very least, and not as an attempt to limit interpretation or the application of the doctrine of equivalents to the scope of the claims, each numerical parameter should at least be construed in light of the number of significant digits and by applying ordinary rounding techniques.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements.

### Ranges Intended to Disclose Sub-Ranges

Moreover, all ranges disclosed herein are to be understood to encompass any and all sub-ranges subsumed therein. For example, a range of “1 to 10” includes any and all sub-ranges between (and including) the minimum value of 1 and the maximum value of 10, that is, any and all sub-ranges having a minimum value of equal to or greater than 1 and a maximum value of equal to or less than 10, e.g., 5.5 to 10.

### Application of Claim Differentiation

It is also to be further understood that the doctrine of claim differentiation is to be applied across an independent claim and its dependents and is not intended to be applied across a plurality of independent claims. For example, term A in a first independent may be interpreted to have the same scope as term B in second independent claim, while if term A is in a first independent claim and term B further defines term A in a claim dependent from the first independent claim, then term A must have a broader scope than term B. In other words, phrases that differ from one independent claim to another independent claim, may be interpreted to have equal scope and read on common structure yet present the structure using different terminology in order account for differing interpretation of phrase language.

### Negative Limitations Intended

The following description and related drawings are to be understood to positively disclose structure having direct connection of elements, i.e., without an intervening element or elements, where elements are so shown and/or so described as connected, but are not to be interpreted as requiring exclusion of intervening elements, unless explicitly stated, regardless of whether such intervening elements are shown, stated, or Claimed. Likewise with regard to compositions, the following description and related drawings are to be understood to positively disclose compositions without substances or elements other than so described and/or shown, but are not to be interpreted as requiring exclusion of other substances or elements, unless explicitly stated, regardless of whether such additional substances or elements are shown, stated, or Claimed. Similarly, the following description and related drawings are to be understood to positively disclose processes having directly following operations or steps, i.e., without an intervening operations or steps, where operations or steps are so shown and/or so described as directly following one another, but are not to be interpreted as requiring exclusion of intervening operations or steps, unless explicitly stated or Claimed, regardless of whether such intervening operations or steps are shown, stated, or Claimed.

### Featured Interchanged and Transfer Implicit

Various embodiments of the present invention are disclosed herein each having features associated with the particular embodiment. It is to be understood that unless functionally precluded, features of a first embodiment are considered to be disclosed as interchangeable with features of a second embodiment where similar functions are performed, or includable in a second embodiment where an equivalent feature is not explicitly disclosed. For example, if a first embodiment includes a first type of fastener, and a second embodiment includes a second type a fastener performing a like function, it is considered implicitly disclosed that the first embodiment may also employ the second type fastener and vice versa. Similarly, if the second embodiment lacked a corresponding second type fastener, but functioning of the first type fastener in the second embodiment is not structurally or operably precluded, it is to be understood that the first type fastener is applicable and transferable to the second embodiment.

### Embodiments of the Disclosure

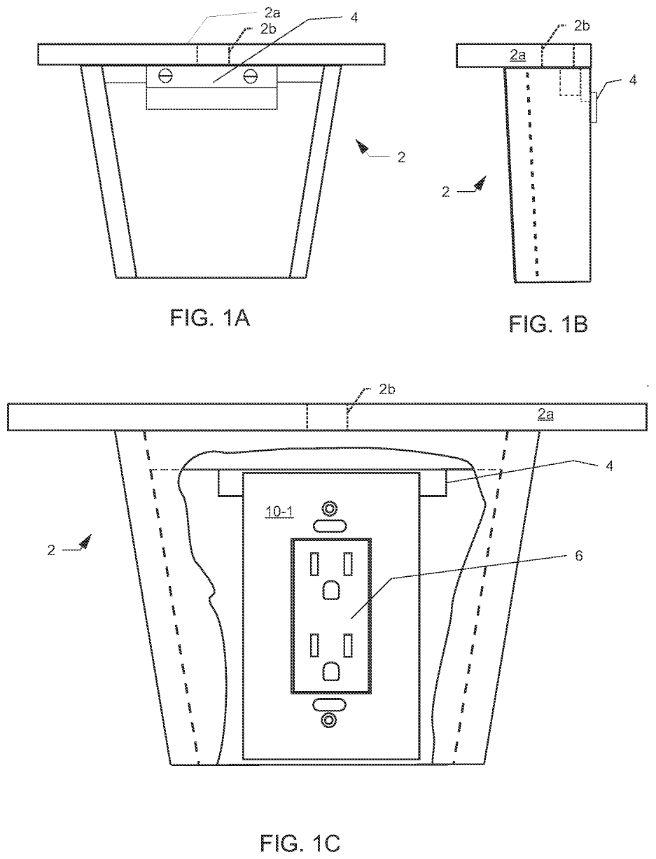

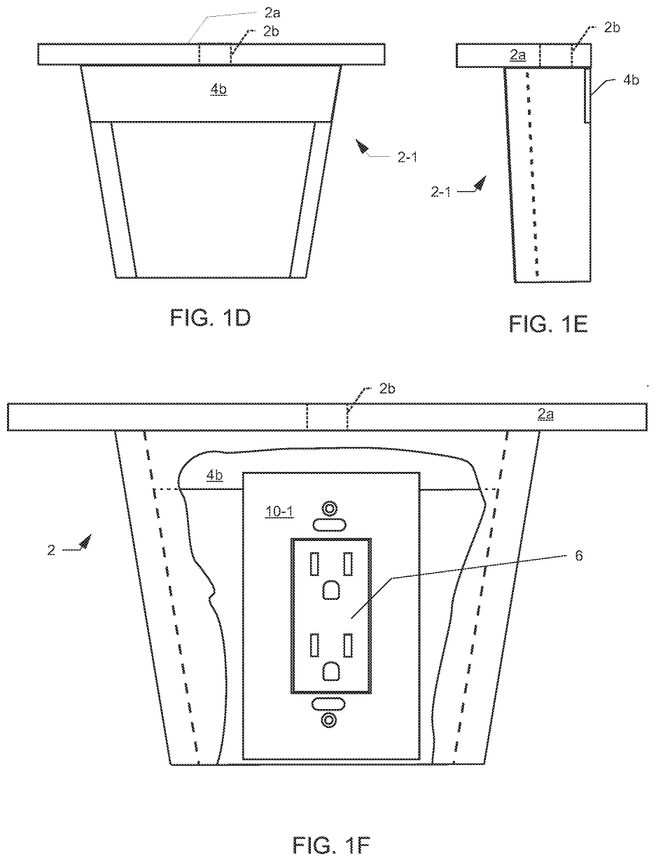

Referring to FIG. 1A-1C, there is shown a shelf assembly 2 having a shelf 2a. An embodiment of the present invention comprises a mounting member 4 which engages an embodiment of a faceplate 10-1 of the present invention to thereby support the shelf assembly 2 on a wall whereat the faceplate 10-1 is mounted to at least one of an electrical receptacle 6 (or an electrical switch) or an electrical box (hidden by faceplate 10-5). The shelf 2a has an aperture 2b of sufficient size to permit electrical connection cords to pass through so that electronic devices placed on the shelf 2a have access to power at the receptacle 6.

Referring to FIGS. 1D-1F, an alternative embodiment is shown wherein a shelf unit 2-1 has a mount member 4b in place of the mounting member 4. The mounting member 4b is configured to engage the faceplate 10-1. Engagement of the faceplate 10-1 and other embodiments thereof are described below.

Electrical devices mounted in electrical boxes generally have a protruding surface which may be that of an electrical receptacle (often referred to as an “outlet”), a switch (toggle or rocker) and frame thereof, or a jack for ethernet, telephone or other electrical signal source. While the description below makes reference to an electrical receptacle, it is to be understood that any of the forgoing types of electrical device protrusions from electrical devices may be accommodated by the present invention. Hence, recitation of a receptacle aperture herein is to be considered a non-limiting example of an electrical device protrusion aperture configured to receive any of the foregoing stated protruding surfaces of an electrical device.

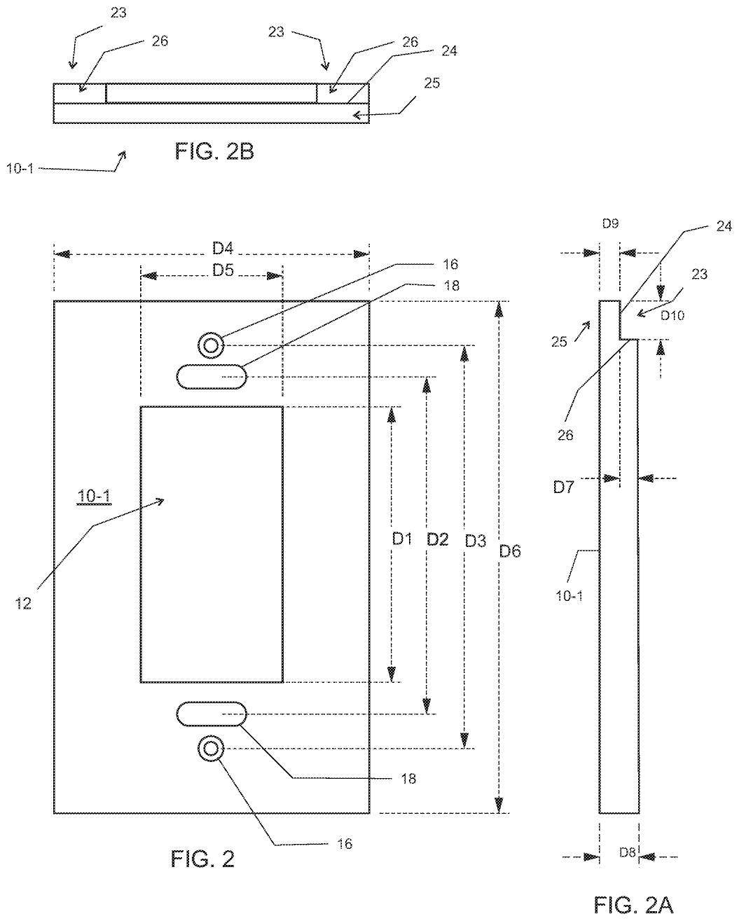

Referring to FIGS. 2-2B, a first embodiment of a faceplate 10-1 is shown wherein FIG. 2 shows a front side of the faceplate 10-1 having a receptacle aperture 12 configured to accept commercially available electrical receptacles. Due to common formats of commercially available receptacles and switches, the receptacle aperture also accommodates commonly available electrical switches. Receptacle fastening holes 16 allow passage of screws (not shown) for fastening of the faceplate 10-1 to an electrical receptacle bracket and are shown optionally having a countersunk configuration for accepting flathead or oval head screws. Clearance apertures 18 are provided to allow screwdriver access to electrical box fastening screws (not shown) which are used to fasten the electrical receptacle to the electrical box. The clearance apertures are oblong to allow adjustment of the electrical receptacle and the faceplate 10-1 to a plumb orientation. Typically, 6-32 screws are used in fastening electrical receptacles and faceplates so clearance apertures 18 and receptacle fastening holes 16 are optionally dimensioned accordingly. Embodiments of the present invention described herein may be configured to accept other screw sizes as applications may warrant.

Generally, original construction electrical outlet boxes are fastened to wall studs and are acceptably plumb. However, often times post construction electrical boxes are not perfectly plumb and adjustment of the faceplate 10-1 to a plumb position is desired so the oblong clearance apertures 18 are configured to allow screwdriver access to heads of the typical 6-32 screws. The spacing D2 of the clearance holes and D3 of the receptacle fastening holes are preferably 3.38″ and 3.81″ which is the present industry standard. Nonetheless, it is to be understood that dimensions D1, D2, D3, and D5 are exemplary and it is within the scope of the present invention that these dimension may be modified to conform to other or future receptacle and switch designs.

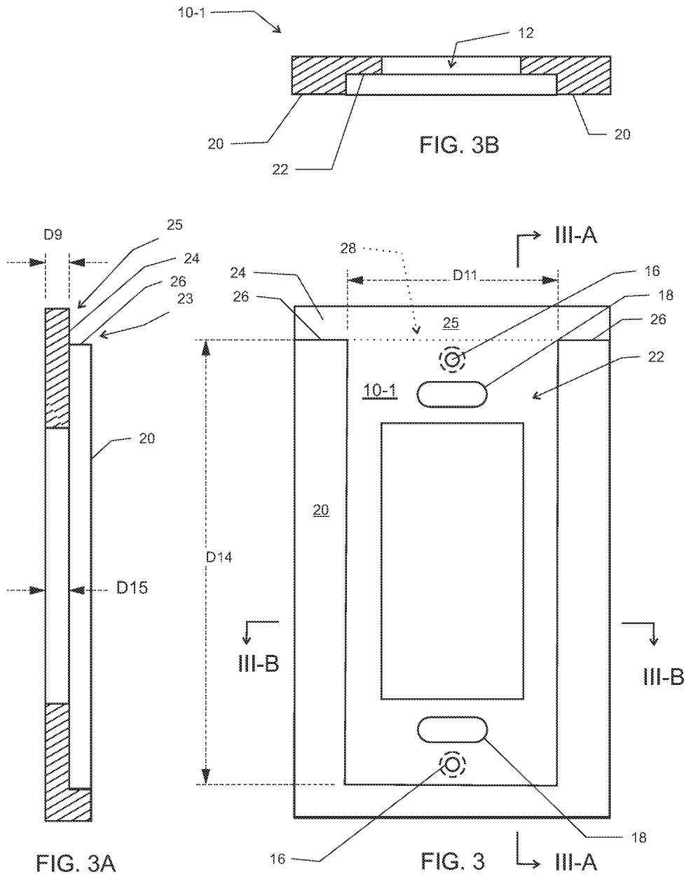

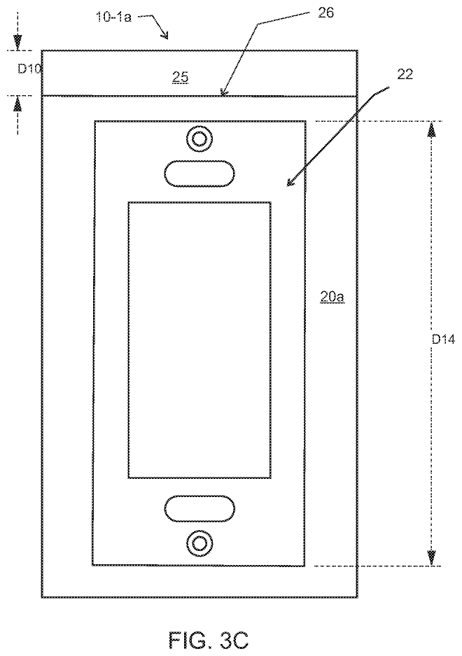

Table 1 below provides approximate dimensions called out in FIGS. 2, 2A, 3 and 3A. The dimensions presented are exemplary and are not considered limiting unless specifically called out in appended claims.

TABLE 1

| Dimension | Minimum (In.) | Preferred |
|---|---|---|
| D1 | 2.62 | 2.66 |
| D2 | 3.20 | 3.28 |
| D3 | 3.78 | 3.81 |
| D4 | about 2.75 | 3.00 |
| D5 | about 1.3 | 1.35 |
| D6 | about 4.5 | 5.50 |
| D7 | about .03 | 0.19 |
| D8 | about .3 | 0.50 |
| D9 | about .125 | .18 |
| D10 | about .125 | .375 |
| D11 | about 1.3 | 1.5 |
| D14 | about 4.1 | 4.3 |
| D15 | about .2 | about .3 |

Common one gang electrical boxes are dimension to be 2″ wide and 3″ inches high which means that typical wallboard openings are slightly larger, generally about 2.25″ to 2.5″ wide and about 3.8″ inches high. Often times the opening is larger so it is desired that the faceplate 10-1 cover the entire wall board opening with excess of about 0.25 inches on the sides and bottom. This yields a preferred minimum plate width D4 of about 2.75 for the faceplate 10-1 and a preferred minimum plate height D6 of about 4.5 inches. There are also situations wherein the wallboard opening is larger than conventional and commercially available faceplates are available having increased dimensions and are often referred to a “large” or “jumbo.” Therefore, the present invention includes embodiments wherein the outer dimensions of the faceplate 10-1 (and other embodiments thereof described herein) are likewise increased. Furthermore, the present invention includes modifying the faceplate 10-1 and its alternative embodiments to include configurations for two or more gang electrical boxes as is commonly done for conventional faceplates.

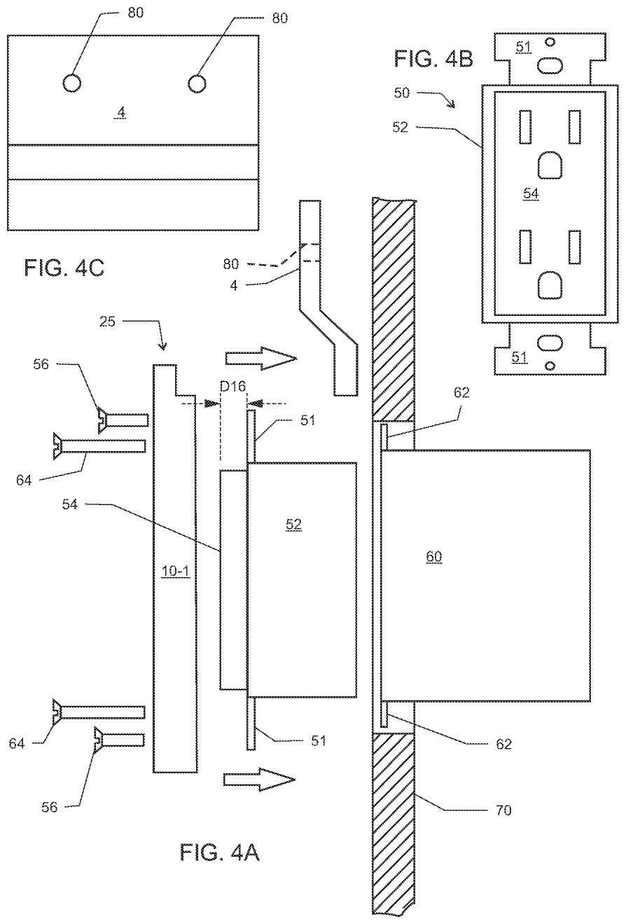

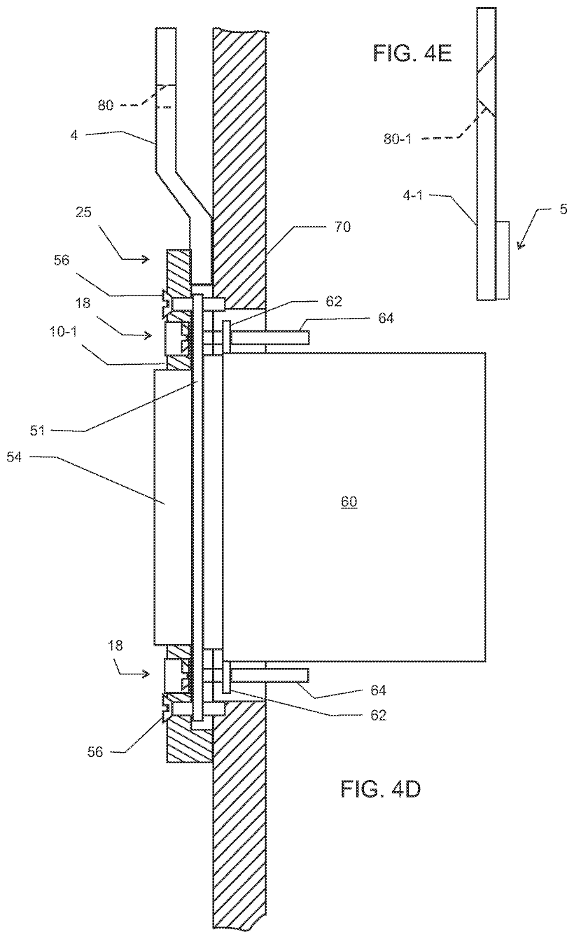

The top edge of the faceplate 10-1 includes a notches 23 defined by a notch side 24 and notch bottoms 26. The notches 23 in turn define a top flange 25 having a flange thickness D9 which is preferably about 3/16″ and a flange height D10 which is preferably about ⅜″. A notch depth D7 is configured to engage the mounting member 4 such that the mounting member 4 is preferably clamped against the wallboard by the flange 25 when a backside of the rib 20 is abutted against a wallboard 70 as shown in FIG. 4D. Alternatively, embodiments of the present invention include the notch 23 and mounting member 4 being configured such that the mounting member 4 is not clamped but merely sits in the notch 23.

A further alternative configuration provides that the notch depth D7 is set to correspond to a thickness of the mounting member 4 which is optionally formed of standard sheet metal gauges 22 (thickness 0.0299″) and lower. The notch depth D7 is then set to provide a slip fit or press fit engagement between the flange 25 and the wallboard. When a slip fit is desired the notch depth 7 is set to a range of about equal to a selected sheet metal gauge thickness to the selected sheet gauge thickness plus about 0.01″ to 0.06″. A preferred embodiment provides a press fit (clamping embodiment) wherein a desired the notch depth 7 is set to a range of about a selected sheet metal gauge thickness minus 0.01″ to the selected sheet gauge thickness minus about 0.1″. Sheet metal gauges 18 and lower are preferred. Sheet metal gauge thickness are presented in Table 2 below.

TABLE 2

| Gauge | Thickness | |
|---|---|---|
| Number | in | mm |
| 3 | 0.2391 | 6.073 |
| 4 | 0.2242 | 5.095 |
| 5 | 0.2092 | 5.314 |
| 6 | 0.1943 | 4.935 |
| 7 | 0.1793 | 4.554 |
| 8 | 0.1644 | 4.176 |
| 9 | 0.1495 | 3.797 |
| 10 | 0.1345 | 3.416 |
| 11 | 0.1196 | 3.038 |
| 12 | 0.1046 | 2.657 |
| 13 | 0.0897 | 2.278 |
| 14 | 0.0747 | 1.897 |
| 15 | 0.0673 | 1.709 |
| 16 | 0.0598 | 1.519 |
| 17 | 0.0538 | 1.367 |
| 18 | 0.0478 | 1.214 |
| 19 | 0.0418 | 1.062 |
| 20 | 0.0359 | 0.912 |
| 21 | 0.0329 | 0.836 |
| 22 | 0.0299 | 0.759 |

In an alternative embodiment the flange 25 does not extend across the entire top side of the faceplate 10-1 but instead is limited to a central portion of the top side of the faceplate 10-1. The rib 20 then extends up to a top edge of the faceplate 10-1. This alternative embodiment provides increased strength by reinforcing the flange 25 at ends thereof.

The mounting member 4 is shown in FIGS. 1A-1C as a bracket which is mounted to or supports an article (shown exemplary as a shelf assembly 2). It is to be understood that the scope of the present invention includes the mounting member being part of a structure of the article to be supported as is shown in FIGS. 1D-1F wherein mounting member 4b is used. Furthermore, in the case of the notch 23 being limited to a central portion of the top side of the faceplate 10-1, any embodiment of the mounting member 4 is modified accordingly to have a tab that fits into the central portion notch.

One skilled in the art will realize that the configuration of the notches 23, flange 25, and the mounting member 4 is application and material dependent. For light duty applications the flange thickness D9, notch depth D7, flange height D10 may be minimized. For heavy duty applications the flange thickness D9, notch depth D7, flange height D10 are increased to meet the requirements of the application. Furthermore, a material of the faceplate 10-1 will also dictate dimensions. The faceplate 10-1 is optionally formed of, for example and not limitation, a polymer, metal, metal alloy, ceramic, glass, or wood. The mounting member 4 is likewise formed of any of said materials. The strength of the chosen material will also dictate dimensions.

Referring FIGS. 3-3B, a back side embodiment of the faceplate 10-1 is shown. A rib 20 defines a recessed area 22, or concavity, which accommodates a receptacle bracket 51 and receptacle body 52 of a receptacle 50 shown in FIGS. 4A and 4B. Typical receptacles have a protruding surface in the form of an outlet frame 54 which protrudes from the receptacle bracket 50 a protruding distance D16 which varies depending on the type of receptacle and manufacturer with a nominal protrusion distance being about 0.2″, and others, such as receptacles that include GFCI and USB charging features, having a protrusion distance ranging up to about 0.32″ or more. It is desirable that the front surface of the faceplate 10-1 be about flush with a front of the outlet frame 54 but this is not a requirement. Thus, a faceplate thickness D15, shown in FIG. 3A, is nominally set to about 3/16″ such that the outlet frame 54 slightly protrudes when the receptacle 50 and faceplate 10-1 are assembled together.

The notch face 24 defines a notch recess area 28 (shown by dotted line) which is shown coplanar with the recessed area 22. However, it is to be understood that the notch recessed area 28 and the recessed area 22 need not be coplanar as each may be dictated by different requirements. The notch recessed area 28 determines a flange thickness D9 which may be determined by structural support requirements of an application while the faceplate thickness D15 may be adjusted to accommodate differing types of receptacles.

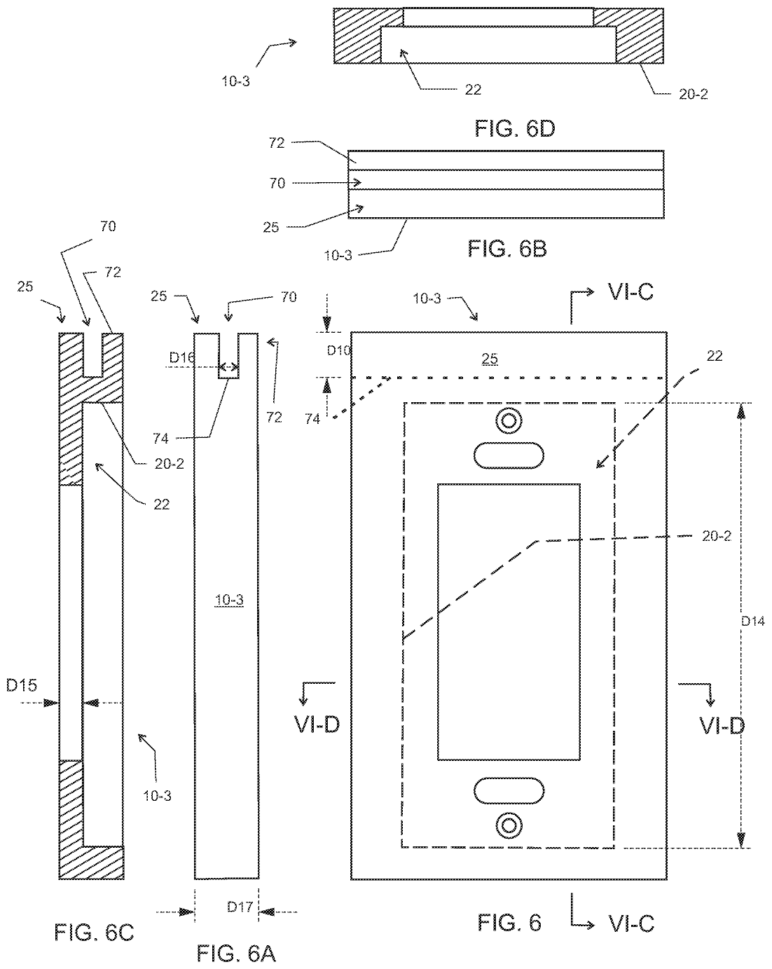

The faceplate 10-1 is shown having rib 20 with separated top ends. However, referring to FIG. 3C, an alternative embodiment within the scope of the present invention is shown as faceplate 10-1a wherein the rib 20 is replaced with rib 20a which is continuous across a top portion of the faceplate 10-1 with a lower side defining the recessed area 22 and an upper side providing a continuous notch bottom 26 extending from a left side to a right side of the faceplate 10-1. In such a configuration, with the recessed area 22 being determined by a receptacle configuration hence limiting a position of a lower side of the rib 20, a flange height D10 is either decreased or the plate height D6 is increased. Another embodiment of the continuous rib is shown in FIGS. 6-6D and described herein in relation to a further embodiment of the present invention wherein the notches 23 are continuous along the rib and further have a second side, thus forming two flanges defining a groove therebetween.

Referring to FIGS. 4A and 4D, the faceplate 10-1, receptacle 50 and electrical box 60 are assembled using bracket screws 56 and electrical box screws 64 as shown. The receptacle bracket 51 is fastened to the electrical box 60 at electrical box ears 62 and the faceplate 10-1 is fastened to the receptacle bracket 51. The fastening is done so as to clamp mounting member 4 between the flange 25 and wallboard 70.

In an alternative embodiment of the faceplate 10-1 the oblong clearance apertures 18 are omitted. During installation of such an embodiment the electrical box screws 64 are first tightened with the receptacle 50 aligned plumb. The faceplate 10-1 is then fastened to the receptacle bracket 51 with the bracket screws 56 to clamp the mounting member 4 between the flange 25 and wallboard 70. In the embodiment absent the oblong clearance apertures 18, the depth D7 of recessed area 22 is set to provide clearance for a thickness of the receptacle bracket 51 and a distance that a head of the electrical box screw 64 protrudes out from the receptacle bracket 51 as shown in FIG. 4D. Alternatively, indentations in the recess area 22 may be provided to accommodate heads of the electrical box screws 64. When the oblong clearance apertures 18 are present the heads of the electrical box screws 64 may protrude into the oblong clearance apertures 18 so that the depth D7 may be less to fit a thinner embodiment of the mounting member 4.

The mounting member 4 is shown in an optional offset configuration in FIGS. 4A and 4C, however this is not required and an alternative flat mounting member 4-1 shown in FIG. 4E may also be used. The mounting members 4 and 4-1 are optionally provided with holes 80 and 80-1 for accepting mounting screws to attach a structure to be supported. Alternatively, any mounting member described herein may be attached to a structure using an adhesive either applied to the mounting member or provided as an adhesive backing material attached to the mounting member and having a peel off film permitting removal of the film to attach the mounting member to a structure. Mounting members described herein are configured to have a height above a top of any faceplate embodiment described herein to position mounting holes 80 preferably at least 0.5 inches above the top of a faceplate, and more preferably 1 or more inches above the top of the faceplate. As previously noted, a further alternative is that a structure to be supported incorporates a portion which substitutes as a mounting member to fit between the flange 25 and the wallboard 70 as shown in FIGS. 1D-1F.

In a further embodiment of the present invention, the mounting member 4 or 4-1 is provided with an elastic material 5 which is compressed when the mounting member is clamped by the flange 25 and thus provides enhanced stability of the assembly by virtue of ensuring clamping force in the event the mounting member thickness does not correspond to the notch depth D7 and also providing an increased coefficient of friction between the mounting member 4-1 and the wallboard 70. The elastic material 5 is optionally applied to the mounting member 4 or 4-1 on the side facing the flange 25, or on both sides, and may also be applied to the notch side 24.

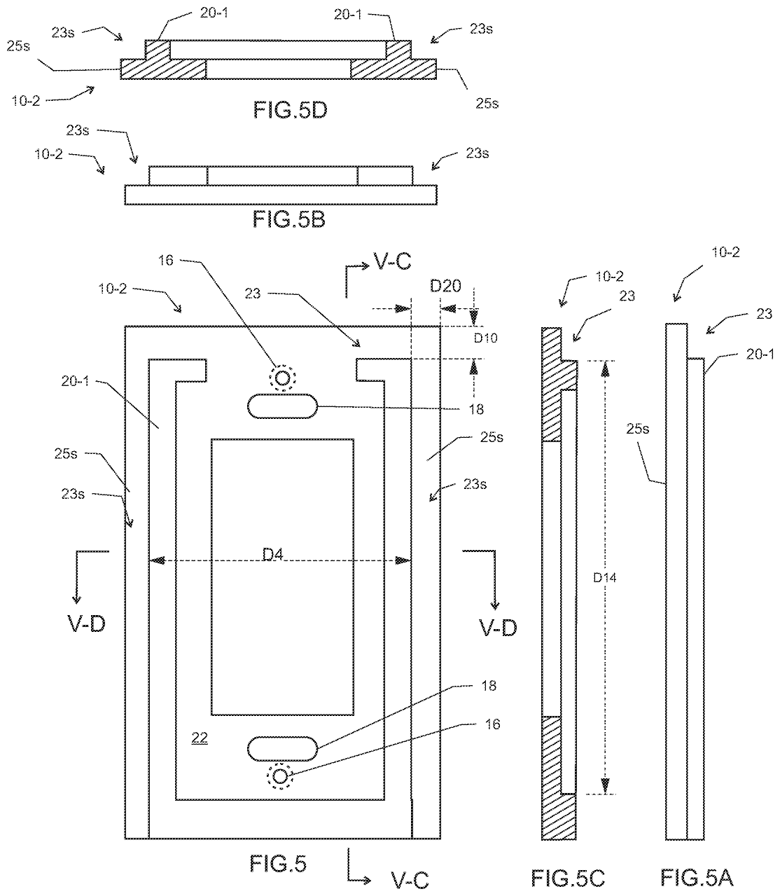

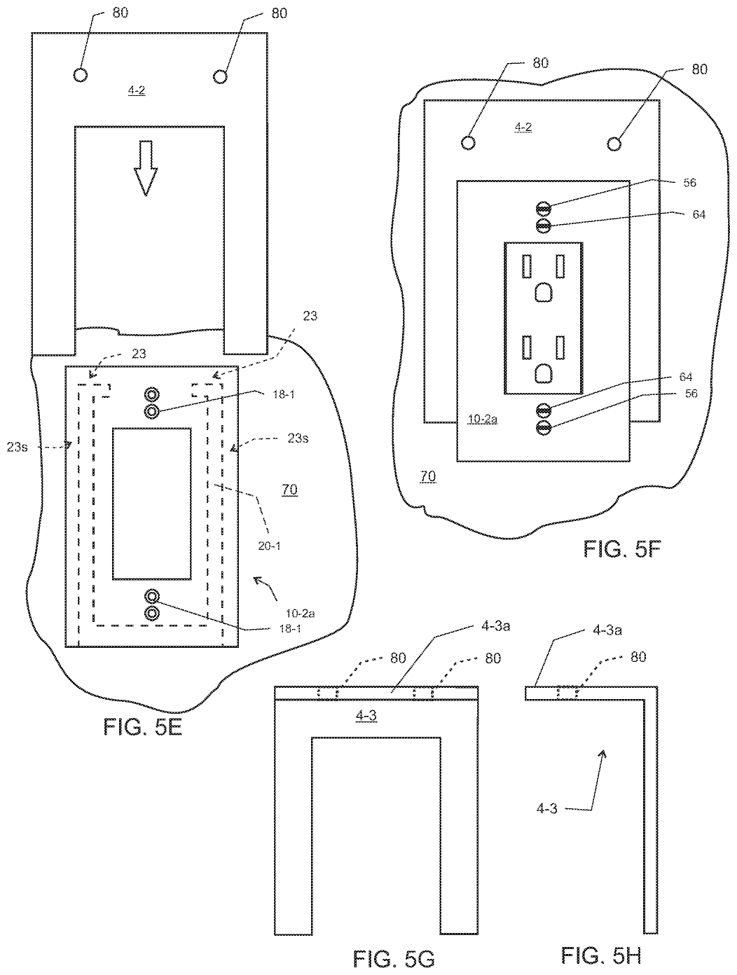

Referring to FIGS. 5-5D, a faceplate 10-2 is shown which is another embodiment of the present invention and varies from the embodiment of faceplate 10-1 as described herein. The rib 20 of faceplate embodiment 10-1 is replaced with rib 20-1 which is recessed from side edges of the faceplate 10-2 to form side notches 23s which are optionally dimensioned to have notch depth D7 about the same as the notch 23. The side notches 23s define side flanges 25s which have a side flange width D20 determined similarly to the flange height D10 but need not be equal to flange height D10. Since the faceplate 10-2 incorporates the side flanges 25s defined in part by rib 20-1, the faceplate 10-2 is optionally wider than faceplate 10-1 because the rib 20-1 preferably engages the wallboard 70 when the faceplate 10-2 is installed so a width across outer edges of the rib 20-1 is set as the plate width D4 used in the faceplate 10-1. A further embodiment (not shown) includes the side notches 23s extending from the top of faceplate 10-2 partially down the sides and ending before reaching the bottom of the faceplate 10-2.

Referring to FIGS. 5E and 5F, assembly of a faceplate 10-2a, which is a further embodiment of faceplate 10-2, and a forked mounting member 4-2 is shown having structure mounting holes 80. The faceplate 10-2a is the same as faceplate 10-2 except that the oblong clearance apertures 18 are replaced with box fastening holes 18-1 for accepting the electrical box screws 64 and permitting fastening of the faceplate 10-2 to the electrical box 60. The box fastening holes 18-1 are shown optionally countersunk for flathead or oval head screws, but may be counterbored for panhead screws. This configuration does not provide for plumb adjustment of the faceplate 10-2 which is often not required when electrical boxes are properly installed. In a further variation the box fastening holes 18-1 may be made oblong to provide for plumb adjustment. In either variation, the faceplate 10-2 is directly fastened to the electrical box 60 by the electrical box screws 64 similar to as shown in FIG. 4D with the exception that heads of the electrical box screws 64 do not pass clear through the oblong clearance holes 18 but instead engage the faceplate 10-2 at the box fastening holes 18-1. This arrangement provides for direct support of the faceplate 10-2 by the electrical box 60 which, in new construction situations, is mounted to a wall stud.

The forked mounting member 4-2 is configured to engage the notch 23 and the side notches 23s of the faceplate 10-2. As shown in FIG. 5E, the forked mounting member 4-2 is slid down to engage the notches 23 and 23s and be retained by clamping between the wallboard 70 and the top flange 25 and side flanges 25s by advancement of the faceplate 10-2 toward the wallboard 70 via tightening of the electrical box screws 64. The forked mounting member 4-2 is thus secured as shown in FIG. 5F.

Referring to FIGS. 5G and 5H, an alternative right angle mounting member 4-3 is shown having structure engagement holes 80 in a right angle extension 4-3a. The extension of notches 23s down sides of the faceplate 10-2 provides added stability for supporting a shelf type structure above the receptacle or switch outlet using the right angle extension 4-3a. When downward force is applied to an end of the right angle extension 4-3a, torque pivoting around the top of the faceplate 10-2a results and is resisted by the wallboard 70.

Referring to FIGS. 6-6D, a faceplate 10-3 is shown which is another embodiment of the present invention and varies from the embodiment of faceplate 10-1 as described herein. The notch 23 is modified to extend across a top of the faceplate 10-3 and further has a back side forming a second flange 72 defining a groove 70 which is configured to accept mounting member 4, 4A or 4-1. The groove width D16 and a thickness of a chosen mounting member are selected based on application requirements. For exemplary purposes, the groove width D16 and thickness of the chosen mounting member are optionally set to correspond to standard sheet metal gauges 22 (thickness 0.0299″) and lower permitting slip fit or press fit engagement. A faceplate side thickness D17 is set to accommodate the faceplate thickness D15, groove width D16, and a nominal thickness of the second flange 72, preferably but not limiting, about 0.125,″ ensuring clearance for a thickness of the receptacle bracket 51.

A rib 20-2 replaces rib 20 and has a thickness, which in conjunction with faceplate thickness D15, provides the faceplate side thickness D17. The rib 20-2 extends across a top width of the faceplate 10-2 incorporating the groove 70. Groove bottom 74 is shown by dotted line in FIG. 5. Alternatively, the rib 20-2 need not extend across the top width of the faceplate 10-3 but may be discontinuous at a center portion. The rib 20-2 defines the recessed area 22 for receiving the receptacle bracket 51 and the receptacle body 52.

In a still further embodiment the groove 70 need not extend across the entire top of the faceplate 10-3 but may instead be limited to a portion removed from sides of the faceplate 10-3. In such a configuration the rib 20-2 is solid at sides of the top of the faceplate 10-3 which in turn reinforces the second flange 72. When this alternative configuration is used, any of the mounting members described herein are configured with a tab to mount into the limited portion groove.

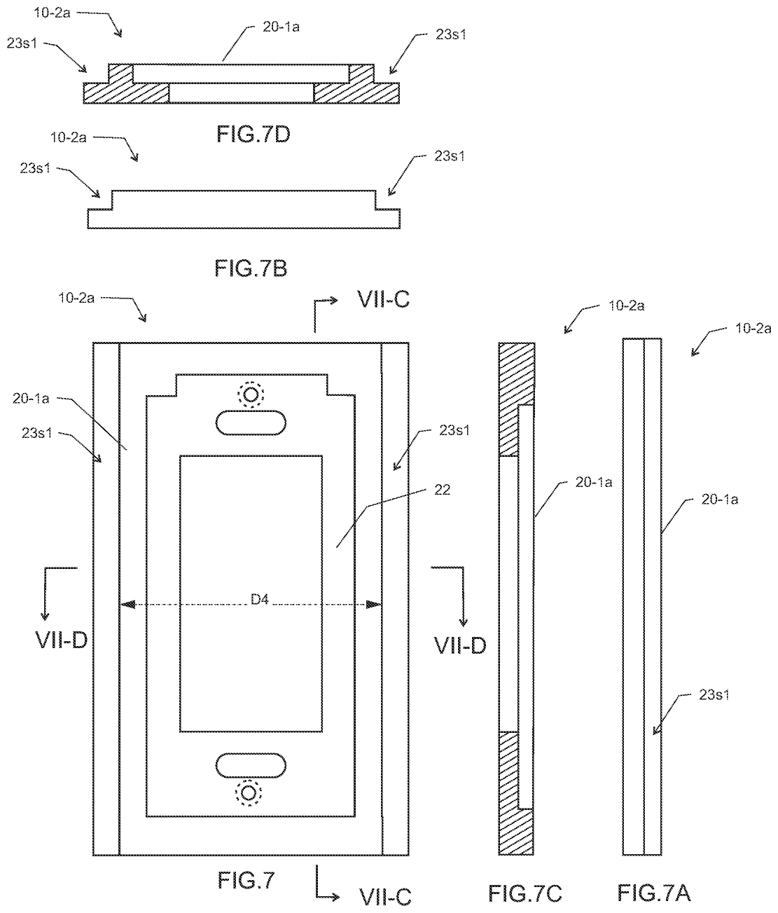

Referring to FIGS. 7-7D, there is shown a faceplate 10-2a which is the same as faceplate 10-2 except as described herein. Rib 20-1a replaces rib 20-1 and extends up to the top edge of the faceplate 10-2a thereby eliminating the notch 23 shown on top in FIG. 5. Side notches 23s1 extend from the top of the faceplate 10-2a to the bottom. It is preferable that the rib 20-1a engage wallboard at sides when installed so a distance across outer edges of the rib 20-1a is optionally set to the plate width D4 of the faceplate 10-1 embodiment. For situations where wallboard openings are larger, optionally any embodiments of faceplates described herein are accordingly increased in size. A further embodiment includes the side notches 23s1 extending from the top of faceplate 10-2a partially down the sides and ending before reaching the bottom of the faceplate 10-2a. The forked mounting member 4-2 engages the faceplate 10-2a in the manner as shown in FIGS. 5E and 5F with the exception that the forked mounting member 4-2 rests on the top of the faceplate 10-2a. The rib 20-1a similarly defines the recessed area 22.

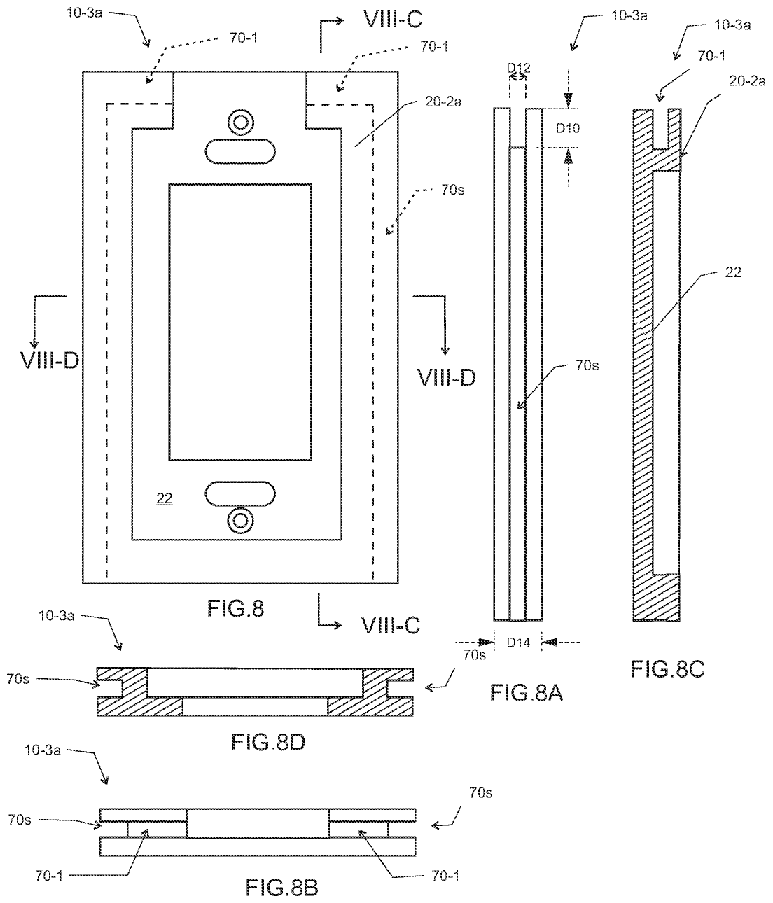

Referring to FIGS. 8-8D, there is shown a faceplate 10-3a which is the same as faceplate 10-3 except as described herein. Rib 20-2a replace rib 20-2 and defines side grooves 70s. Side grooves 70s extend from a bottom of a top groove 70-1 to the bottom of the faceplate 10-3a. Rib 20-2a is discontinuous at the top of the faceplate 10-3a and top groove portions 70-1 are formed in place of groove 70 of the faceplate 10-3. A further embodiment includes the side grooves 70s extending partially down the sides and ending before reaching the bottom of the faceplate 10-3a. The forked mounting member 4-2 engages the faceplate 10-3a in the manner as shown in FIGS. 5E and SF. The rib 20-2a similarly defines the recessed area 22.

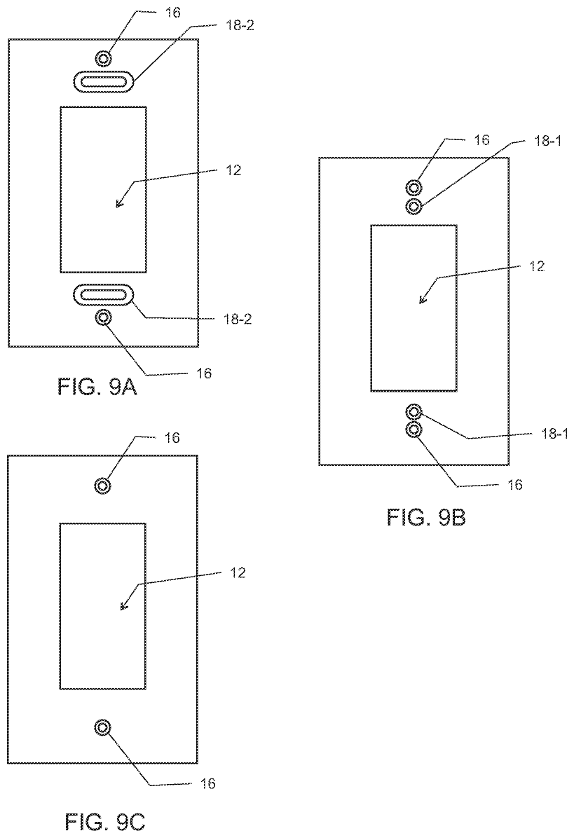

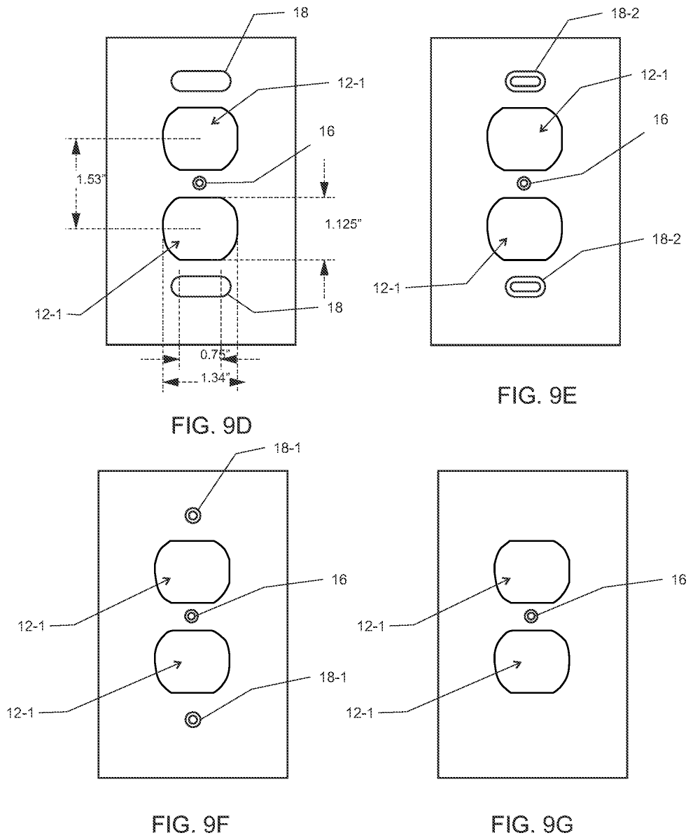

FIGS. 9A-9C illustrate alternative screw hole configurations for any of the aforesaid embodiments of faceplates having receptacle aperture 12. FIG. 9A shows an embodiment wherein the oblong clearance holes 18 are replaced with oblong box fastening holes 18-2. The oblong box fastening holes 18-2 are either countersunk or counterbored and engage heads of the electrical box screws 64 while allowing adjustment of the faceplate to plumb. FIG. 9B shows the oblong clearance holes replaced with the box fastening holes 18-1. FIG. 9C shows a faceplate omitting the oblong clearance holes 18. In this embodiment the receptacle is securely fastened to the electrical box 60 prior to installation of the faceplate.

FIGS. 9D-9G illustrate alternative receptacle openings for any of the aforesaid faceplate embodiments which accept older style receptacles. FIG. 9D provides exemplary and non-limiting dimensions of older receptacle apertures 12-1. The embodiment of FIG. 9D has the faceplate attached via receptacle fastening hole 16 and has the oblong clearance aperture holes 18. An embodiment shown in FIG. 9E has the faceplate attached via receptacle fastening hole 16 and has the oblong box fastening holes 18-2. An embodiment shown in FIG. 9F has the faceplate attached via receptacle fastening hole 16 and has the box fastening holes 18-1. An embodiment shown in FIG. 9G has the faceplate attached via receptacle fastening hole 16.

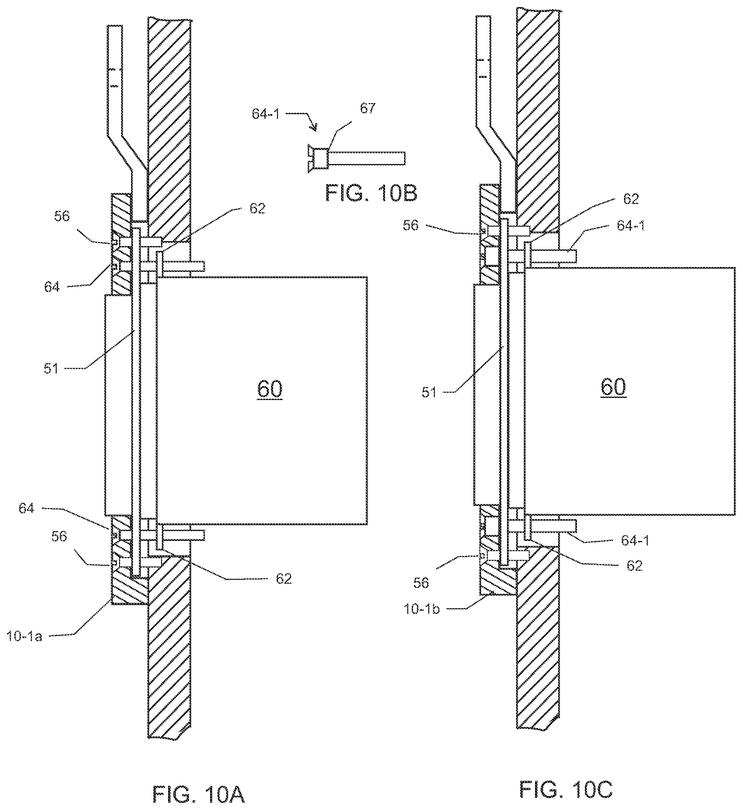

FIG. 10A shows an assembly of a faceplate 10-1a which is the same as faceplate 10-1 with the screw hole configuration of FIG. 9B. The receptacle fastening screws 56 secure the receptacle bracket 51 to the faceplate 10-1a. The electrical box screws 64 in turn secure the faceplate 10-1a to the electrical box 60 via electrical box ears 62. There are situations wherein older receptacle installations do not have a ground wire connection to the receptacle 50 and instead the receptacle 50 is grounded via screw connection to the electrical box ears 62. In order to provide an enhanced ground connection a modified electrical box screw 64-1 shown in FIG. 10B is optionally used. The modified electrical box screw 64-1 is provided with a shank 67 which is configured to engage the receptacle bracket 51 when in the installed position shown in FIG. 10C. Electrical receptacles generally have a clearance hole for a fastening screw to pass through to be screwed into an electrical box. The clearance hole typically has about a 0.185″ height and has an oblong width of about 0.28″ to allow plumb adjustment of the electrical device. Thus a diameter of shank 67 is about 0.19″ or greater, preferably about 0.2″. A screw head of a 6-32 screw is generally about 0.27″ in diameter so a shank diameter of about 0.2″ leaves about a 0.035head overhang to engage a countersunk hole configured to accept the modified electrical box screw 64-1. The shank 67 has a shank length so that, when the screw head is seated in the box fastening hole 18-1, the shank 67 is set to protrude from the surface of the concavity 22 a distance of in the range of about 0.01″ to about 0.05″ to engage the receptacle bracket 51 to make electrical contact. These dimensions are optional and may be varied from depending upon application. The faceplate 10-1b is an alternative embodiment of the faceplate 10-1a having either the box fastening hole 18-1 or the oblong box fastening hole 18-2 modified to provide clearance for the shank 57 thereby allowing the shank 67 to contact the receptacle box bracket 51 and effect grounding via screwed connection to electrical box ears 62.

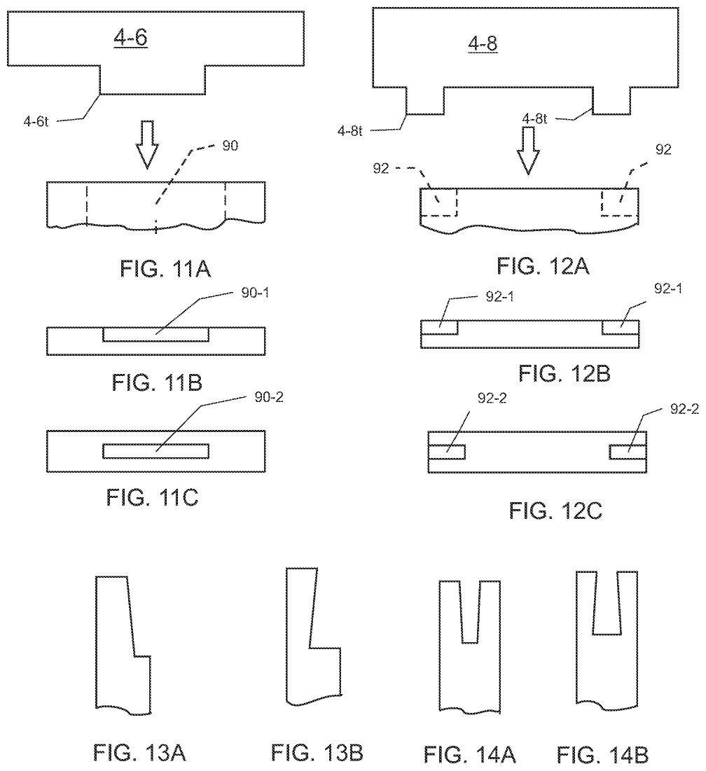

Referring to FIG. 11A an assembly diagram illustrates an embodiment of any the forgoing faceplates modified such that notches of aforesaid embodiments, shown as a top surface indentation 90, do not extend to the sides of the faceplate and comprise one of a notch 90-1 shown in FIG. 11B or a groove 90-2 shown in FIG. 11C. A modified mounting member 4-6 has a tab 4-6t which is configured to engage either of the notch 90-1 or the groove 90-2.

Referring to FIG. 12A an assembly diagram illustrate an embodiment of any the forgoing faceplates modified such that top surface indentations 92 do not extend to a center portion but instead are on ends of a top of the faceplate and are one of notches 92-1 shown in FIG. 12B or grooves 90-2 shown in FIG. 12C. A modified mounting member 4-8 has a tabs 4-8t which are configured to engage either of the notches 92-1 or the grooves 92-2.

FIG. 13A shows an alternative notch configuration which may be used in any of the forgoing faceplate embodiments wherein a side of the notch is inclined outward approaching a notch opening. FIG. 13B shows an alternative notch configuration which may be used in any of the forgoing faceplate embodiments having notches wherein a side of the notch is inclined outward from the notch approaching a notch bottom. FIG. 14A shows an alternative groove configuration which may be used in any of the forgoing faceplate embodiments having grooves wherein a groove narrows approaching a groove bottom. FIG. 14B shows an alternative groove configuration which may be used in any of the forgoing faceplate embodiments having grooves wherein a groove widens approaching a groove bottom. In each of the aforesaid alternate notch or groove arrangements a mounting member to be used is accordingly modified to conform to the groove or notch.

It is to be understood that the present invention further includes embodiments of faceplates which additionally have either a notch or a groove along the bottom side of the faceplate embodiment in addition to respectively a notch or groove along the top side. In such configurations side grooves or notches are optionally omitted. A further embodiment of the forked mounting member 4-2 is also provided to engage the top and bottom grooves or notches of the further embodiments of the faceplate. In that configuration the forked member is slid or press fit in from a side of the further embodiments of the faceplate.

While particular embodiments of the present invention have been shown and described, it will be appreciated by those skilled in the art that, based upon the teachings herein, changes and modifications may be made without departing from this invention and its broader aspects and, therefore, the appended claims are to encompass within their scope all such changes and modifications as are within the true spirit and scope of this invention. The true spirit and scope is considered to encompass devices and processes, unless specifically limited to distinguish from known subject matter, which provide equivalent functions as required for interaction with other elements of the claims and the scope is not considered limited to devices and functions currently in existence where future developments may supplant usage of currently available devices and processes yet provide the functioning required for interaction with other claim elements. Furthermore, it is to be understood that the invention is solely defined by the appended claims.

It is also to be further understood that the doctrine of claim differentiation is to be applied across an independent claim and its dependents and is not intended to be applied across a plurality of independent claims. For example, term A in a first independent may be interpreted to have the same scope as term B in second independent claim, while if term A is in a first independent claim and term B further defines term A in a claim dependent from the first independent claim, then term A must have a broader scope than term B. In other words, phrases that differ from one independent claim to another independent claim, may be interpreted to have equal scope and read on common structure yet present the structure using different terminology in order account for differing interpretation of phrase language.

What is claimed is:

1. A faceplate for attaching to at least one of an electrical box or an electrical device in the electrical box and covering a wallboard opening in a wall in which the electrical box is mounted, the electrical device having a protruding surface, the faceplate comprising:
a plate having a front side, a top side, right and left sides, a bottom side, and back side;
said plate defining an electrical device protrusion aperture in said front side extending through said plate and configured to receive the protruding surface of the electrical device;
said plate defining at least one fastener receiving aperture positioned to receive a screw for fastening said plate to one of the electrical device or the electrical box; and
said plate including a notch in at least one of said top side, said left side, or said right side.

2. The faceplate according to claim 1 wherein said notch is formed in said top side, and said notch forms a flange and a notch bottom surface, said flange having a top edge and a flange back surface extending from said top edge to said notch bottom.

3. The faceplate of claim 2 wherein said plate includes a rib extending along at least a portion of a perimeter of said back side, and said rib having a rib top side forming said notch bottom surface.

4. The faceplate of claim 3 wherein and said rib defines a concavity configured to receive a portion of the electrical device.

5. The faceplate of claim 4 wherein said rib has outer right and left edges respectively recessed from said right side and said left side of said plate to define right and left side notches with side walls forming right and left side flanges.

6. The faceplate of claim 3 wherein said notch and said flange back surface extends from said right side to said left side.

7. The faceplate of claim 3 wherein said notch and said flange back surface do not extend to said right side and said left side.

8. A kit for mounting a structure to a wall comprising said faceplate of claim 5 and a mounting member having an edge configured to fit in said top notch and having right and left arms respectively configured to fit said right and left side notches.

9. The kit according to claim 8 wherein said mounting member includes at least one aperture configured to receive a screw for attaching said mounting member to said structure.

10. A method for mounting a structure to a wall including an electrical box and an electrical device situated in said electrical box comprising steps of:
providing the kit of claim 8;
attaching said mounting member to said structure;
fastening said faceplate to one of an electrical box or an electrical device in said electrical box; and
disposing said mounting member with said edge in said top notch and said right and left arms respectively in said right and left side notches.

11. A method for mounting a structure to a wall including an electrical box and an electrical device situated in said electrical box comprising steps of:
providing the kit of claim 8;
attaching said mounting member to said structure; and
fastening said faceplate to one of an electrical box or an electrical device in said electrical box with said mounting member disposed between said flange and said wall and said right and left arms disposed respectively between said right and left side flanges and said wall, wherein said fastening includes clamping said mounting member to said wall.

12. A kit for mounting a structure to a wall comprising said faceplate of claim 2 and a mounting member configured to fit in said notch.

13. The kit according to claim 12 wherein said mounting member includes at least one aperture configured to receive a screw for attaching said mounting member to said structure.

14. A method for mounting a structure to a wall including an electrical box and an electrical device situated in said electrical box comprising steps of:
providing the kit of claim 12;
attaching said mounting member to said structure; and
fastening said faceplate to one of an electrical box or an electrical device in said electrical box with said mounting member disposed between said flange and said wall wherein said fastening includes clamping said mounting member to said wall.

15. A method for mounting a structure to a wall including an electrical box and an electrical device situated in said electrical box comprising steps of:
providing the kit of claim 13;
attaching said mounting member to said structure;
fastening said faceplate to one of an electrical box or an electrical device in said electrical box; and
disposing said mounting member between said flange and said wall.

16. The faceplate according to claim 2 wherein said notch is formed in said top side, and said notch forms a front flange, a back flange, and a notch bottom surface defining a top side groove.

17. The faceplate of claim 16 wherein said plate includes a rib extending along at least a portion of a perimeter of said back side, and said rib forming said top side and including said top side groove

18. The faceplate of claim 17 wherein and said rib defines a concavity configured to receive a portion of the electrical device.

19. The faceplate of claim 17 wherein said rib has a rib right edge and a rib left edge respectively comprising portions of said right and left sides of said plate, said rib right and left edges respectively including right and left side notches defining right and left side grooves extending from said top side and along at least portions of said right and left sides of said plate, said right and left side grooves being aligned with said top side groove.

20. The faceplate of claim 19 wherein said top side groove extends from said right side to said left side and coincides with said right and left side grooves respectively at said right side and said left side.

21. A kit for mounting a structure to a wall comprising said faceplate of claim 19 and a mounting member configured to fit in said top side groove and having arms configured to fit said right and left side grooves.

22. The kit according to claim 21 wherein said mounting member includes at least one aperture configured to receive a screw for attaching said mounting member to said structure.

23. A method for mounting a structure to a wall including an electrical box and an electrical device situated in said electrical box comprising steps of:
providing the kit of claim 21;
attaching said mounting member to said structure;
fastening said faceplate to one of an electrical box or an electrical device in said electrical box; and
disposing said mounting member in said top side groove and said right and left side grooves.

24. A kit for mounting a structure to a wall comprising said faceplate of claim 17 and a mounting member configured to fit in said top side groove.

25. The kit according to claim 24 wherein said mounting member includes at least one aperture configured to receive a screw for attaching said mounting member to said structure.

26. A method for mounting a structure to a wall including an electrical box and an electrical device situated in said electrical box comprising steps of:
providing the kit of claim 24;
attaching said mounting member to said structure;
fastening said faceplate to one of an electrical box or an electrical device in said electrical box; and
disposing said mounting member in said top side groove.

27. The faceplate according to claim 1 wherein said notch includes right and left notches respectively formed in said right and left sides of said plate, said right and left notches respectively forming right and left flanges and right and left notch bottom surfaces, and said right and left notches extending from said top side of said plate to form notch openings in said top side.

28. The faceplate of claim 27 wherein said plate includes a rib extending along at least a portion of a perimeter of said back side, and said rib forming a bottom of said right and left notches and extending along at least a portion of said top side of said plate to form a plate top surface.

29. The faceplate of claim 28 wherein and said rib defines a concavity configured to receive a portion of the electrical device.

30. A kit for mounting a structure to a wall comprising said faceplate of claim 27 and a mounting member having right and left arms configured to respectively fit in said right and left notches and an edge disposed to engage said plate top surface when said right and left arms are fit in said right and left notches.

31. The kit according to claim 30 wherein said mounting member includes at least one aperture configured to receive a screw for attaching said mounting member to said structure.

32. A method for mounting a structure to a wall including an electrical box and an electrical device situated in said electrical box comprising steps of:
providing the kit of claim 27;
attaching said mounting member to said structure; and
fastening said faceplate to one of an electrical box or an electrical device in said electrical box with said mounting member disposed to have said right and left arms respectively in said right and left notches and said edge contacting said plate top surface.

33. The method of claim 32 wherein said fastening includes clamping said right and left arms respectively between said right and left flanges and said wall.

34. The faceplate of claim 1 wherein:
said plate includes a rib extending along at least a portion of a perimeter of said back side, and said rib forming a plate top surface at said top side of said plate;
said rib has a rib right edge and a rib left edge respectively comprising portions of said right and left sides of said plate; and
said notch including right and left side notches formed in said rib right and left edges respectively and defining right and left side grooves extending from said top side and along at least portions of said right and left sides of said plate.

35. A kit for mounting a structure to a wall comprising said faceplate of claim 34 and a mounting member having right and left arms configured to respectively fit in said right and left side grooves and an edge disposed to engage said plate top surface when said right and left arms are fit in said right and left notches.

36. The kit according to claim 35 wherein said mounting member includes at least one aperture configured to receive a screw for attaching said mounting member to said structure.

37. A method for mounting a structure to a wall including an electrical box and an electrical device situated in said electrical box comprising steps of:
providing the kit of claim 34;
attaching said mounting member to said structure;
fastening said faceplate to one of an electrical box or an electrical device in said electrical box; and
disposing said mounting member with said right and left arms respectively in said right and left side grooves and said edge contacting said plate top surface.

38. The kit of claim 12 further comprising:
said fastener receiving aperture be disposed to align with a threaded screw hole in said electrical box;
said plate having a second fastener receiving aperture disposed to align with a threaded screw hole in said electrical device;
an electrical device fastening screw configured to secured said plate to said electrical device when passed through said second receiving aperture and threaded into said threaded screw hole of said electrical device;
an electrical box fastening screw having a head, a shank, and a threaded portion configured to screw into said threaded screw hole in said electrical box;
said fastener receiving aperture being configured to accept said head and said shank and having an aperture depth; and
said shank having a length exceeding said aperture depth such that said shank engages said electrical device when said electrical device is secured to said plate and said plate is secured to said electrical box by said electrical box fastening screw.
